(19) United States
(12) Patent Application Publication
(10) Pub. No.: US 2025/0194737 A1
(43) Pub. Date: Jun. 19, 2025

(54) APPARATUS AND METHOD FOR TREATING A SOLE OF A FOOT, AND SHOE COMPRISING THE APPARATUS

(71) Applicant: Ranlin HUANG, Herent (BE)

(72) Inventor: Ranlin HUANG, Herent (BE)

(21) Appl. No.: 18/978,004

(22) Filed: Dec. 12, 2024

(30) Foreign Application Priority Data
Dec. 13, 2023 (EP) EP23216418.6

(51) Int. Cl. A43B 7/145; A43B 7/144; A43B 7/1464

(52) U.S. Cl. CPC A43B 7/145; A43B 7/144; A43B 7/1464

(57) ABSTRACT

An apparatus for treating a sole of a foot is provided. The apparatus includes a receiving structure for receiving the sole. Additionally, the apparatus includes a pressure application structure configured to apply pressure to the sole along a path while the sole is received by the receiving structure. The path extends from a first end to a second end on the sole. The first end is located at a distal end of the foot 110 between the proximal phalange of the first toe and the proximal phalange of the second toe. The second end is located at the heel of the foot. A first section of the path starts at the first end and extends on the sole along the edge of the metatarsophalangeal joint of the second toe facing the metatarsophalangeal joint of the first toe to the lumbrical muscle of the second toe. A second section of the path connects to the first section and extends along the edge of the lumbrical muscle of the second toe facing the flexor hallucis of the first toe, crosses the tendon of the flexor digitorum longus and ends on the quadratus plantae laterally offset to the intersection of the abductor hallucis and the tendon of the flexor digitorum longus. A third section of the path connects to the second section and extends on the sole along the edge of the quadratus plantae facing the abductor hallucis to the second end.

### FIELD

The present disclosure relates to treating the sole of a foot. In particular, examples of the present disclosure relate to an apparatus for treating a sole of a foot, a shoe and a method for treating a sole of a foot.

### BACKGROUND

Foot massage has a variety of beneficial effects on the human body such as relaxation, improved blood circulation in the feet, pain reduction or lowering blood pressure.

There is a wide range of equipment for foot massage. These devices treat different areas of the foot such as the sole of the foot, the toes or the instep of the foot. Likewise, a wide variety of techniques are used to massage the foot.

It is an object of the present disclosure to provide another option for treating the sole of the foot.

### SUMMARY

The task is solved by an apparatus for treating a sole of a foot, a shoe and a method for treating a sole of a foot according to the independent claims. Further embodiments are provided in the dependent claims, the following description and the drawings.

A first example of the present disclosure relates to an apparatus for treating a sole of a foot. The apparatus comprises a receiving structure for receiving the sole. Additionally, the apparatus comprises a pressure application structure configured to apply pressure to the sole along a path while the sole is received by the receiving structure. The path extends from a first end to a second end on the sole. The first end is located at the distal end of the foot between the proximal phalange of the first toe and the proximal phalange of the second toe.

The second end is located at the heel of the foot. A first section of the path starts at the first end and extends on the sole along the edge of the metatarsophalangeal joint of the second toe facing the metatarsophalangeal joint of the first toe to the lumbrical muscle of the second toe. A second section of the path connects to the first section and extends along the edge of the lumbrical muscle of the second toe facing the flexor hallucis of the first toe, crosses the tendon of the flexor digitorum longus and ends on the quadratus plantae laterally offset to the intersection of the abductor hallucis and the tendon of the flexor digitorum longus. A third section of the path connects to the second section and extends on the sole along the edge of the quadratus plantae facing the abductor hallucis to the second end.

A second example of the present disclosure relates to a shoe comprising an apparatus according to the first aspect. A sole of the shoe is the receiving structure of the apparatus. The pressure application structure of the apparatus is integrated into the sole of the shoe.

A third example of the present disclosure relates to a method for treating a sole of a foot. The method comprises receiving the sole at a receiving structure. Additionally, the method comprises applying, by means of a pressure application structure, pressure to the sole along a path while the sole is received by the receiving structure. The path extends from a first end to a second end on the sole. The first end is located at the distal end of the foot between the proximal phalange of the first toe and the proximal phalange of the second toe. The second end is located at the heel of the foot. A first section of the path starts at the first end and extends on the sole along the edge of the metatarsophalangeal joint of the second toe facing the metatarsophalangeal joint of the first toe to the lumbrical muscle of the second toc. A second section of the path connects to the first section and extends along the edge of the lumbrical muscle of the second toe facing the flexor hallucis of the first toe, crosses the tendon of the flexor digitorum longus and ends on the quadratus plantae laterally offset to the intersection of the abductor hallucis and the tendon of the flexor digitorum longus. A third section of the path connects to the second section and extends on the sole along the edge of the quadratus plantae facing the abductor hallucis to the second end.

By applying pressure to the sole of the foot along the proposed path, beneficial effects on the human body can be achieved, such as relaxation, improved blood circulation in the feet, pain relief or lowering blood pressure.

### BRIEF DESCRIPTION OF THE FIGURES

Some examples of apparatuses and/or methods will be described in the following by way of example only, and with reference to the accompanying figures, in which

FIG. 1 illustrates an example of an apparatus for treating a sole of a foot;

FIG. 2 illustrates example of a path for applying pressure on a sole of a foot;

FIG. 3 illustrates an example of a shoe; and

FIG. 4 illustrates a flowchart of an exemplary method for treating a sole of a foot.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

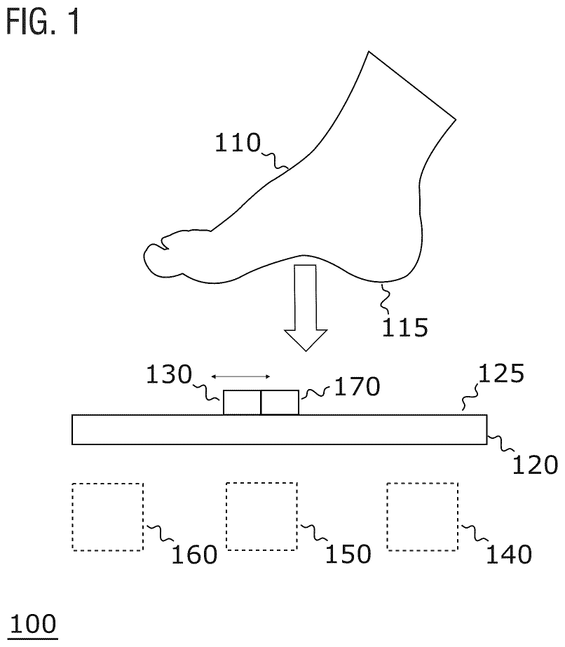

FIG. 1 schematically illustrates an apparatus 100 for treating a sole 115 of a (e.g., human) foot 110. The apparatus 100 may be a mobile (e.g., battery-powered) apparatus or a stationary apparatus.

The apparatus 100 comprises a receiving structure (element, means) 120 for receiving the sole 115. The receiving structure 120 is a rest for the sole 115 to keep the sole in a defined position for the treatment. The receiving structure 120 comprises a surface 125 configured to receive the sole 115. The surface 125 may be made of a soft material such that a user has a comfortable feeling during the treatment. However, the present disclosure is not limited thereto. In other examples, the surface 125 may be made of rigid material. The surface 125 may, e.g., be a textured surface to enhance the comfort of the user during the treatment. According to examples, the apparatus 100 may comprise a heater (not illustrated in FIG. 1) configured to heat the surface 125 to a target temperature (e.g., similar to the human body temperature) to enhance the comfort of the user during the treatment. According to examples, the receiving structure 120 may optionally further comprise one or more fixation structures (means) such as a strap to fixate the foot and/or the sole in defined position with respect to the receiving structure 120 for the treatment.

Additionally, the apparatus 100 comprises a pressure application structure (element, means) 130 configured to apply pressure to the sole along a path while the sole 115 is received by the receiving structure 120.

The pressure application structure 130 may, e.g., be an actuator 130 configured to move relative to the sole 115 while the sole 115 is received by the receiving structure 120. As indicated in FIG. 1, the actuator 130 may be integrated into the receiving structure 120 and be movable relative to the receiving structure 120. For example, a recess (opening) may be provided in the surface 125 such that the actuator extends through the recess and contacts the sole 115 while the sole 115 is received by the receiving structure 120. The recess in the surface 125 is adapted to the path.

The actuator 130 comprises a contact surface (structure, element, means) for contacting the sole 115. The contact surface is driven by a drive system (e.g., comprising an electrical engine for driving the contact surface and a guidance system for guiding the contact surface along the path) of the actuator 130. For reasons of simplicity, only the contact surface for contacting the sole 115 is illustrated in FIG. 1. The contact surface may, e.g., be made of skin compatible (skin tolerable) material. The contact surface may be made of soft material, rigid material or a combination thereof. According to examples, the apparatus 100 may comprise a heater (not illustrated in FIG. 1) configured to heat the contact surface to a target temperature (e.g., similar to the human body temperature) to enhance the comfort of the user during the treatment. Optionally, the contact surface may be non-destructively removable to allow replacement of the contact surface.

In other examples, the pressure application structure 130 may be a static protrusion (ridge) formed on the surface 125. That is, in some examples, the pressure application structure 130 does not move relative to the receiving structure 120 and the sole 115. The extension of the protrusion on the surface 125 may be identical to the extension of the path along which the pressure application structure 130 is to apply pressure to the sole 115. A height of the protrusion on the surface 125 may be constant or vary along the extension of the path to adjust the pressure applied to the sole 115. Like in the above example, also the static pressure application structure 130 comprises a contact surface for contacting the sole 115 (which may be formed as described above) and may be heated.

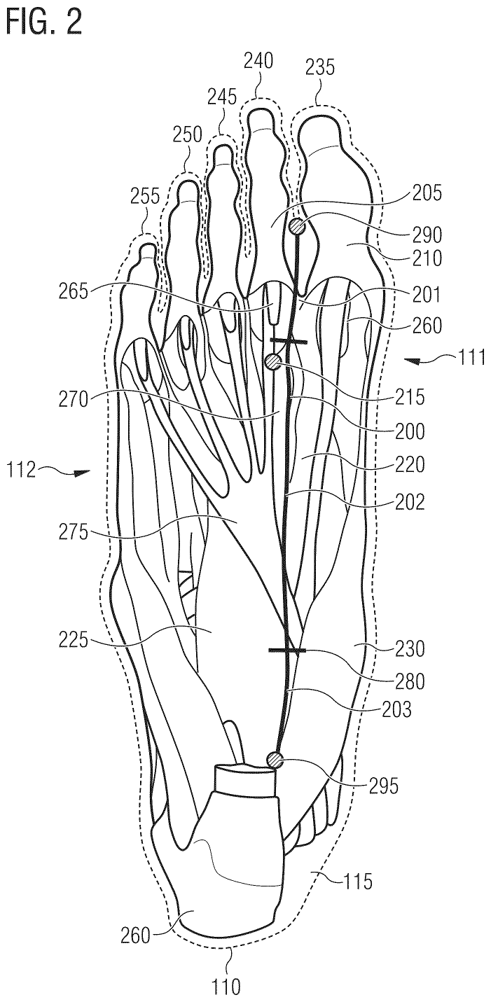

The path 200 along which the pressure application structure 130 is configured to apply pressure is illustrated in FIG. 2. In case the pressure application structure 130 is an actuator, the actuator 130 may be movable in three dimensions such that the actuator 130 is able to move along the path 200 and apply the pressure to the sole 115. In case the pressure application structure 130 is a static protrusion formed on the surface 125, the extension of the protrusion on the surface 125 is identical to the extension of the path 200 to apply the pressure to the sole 115.

FIG. 2 illustrates a plan view of the sole 115 of the foot 110. The path 200 is illustrated together with various muscles, tendons and bones of the foot 110 to highlight the course of the path 200 on the sole 115. It is to be noted that only part of the muscles, tendons and bones is provided with a reference sign for reasons of simplicity. The toes 235 to 255 and the areas connecting the toes 235 to 255 form the distal end of the foot 110. The heel 260 forms the proximal end of the foot 110.

The path 200 extends from a first end 290 to a second end 295 on the sole 115. The first end 290 is arranged at the distal end of the foot 110. The second end 295 is arranged at the proximal end of the foot 110. In particular, the first end 290 is located at the distal end of the foot between the distal half (e.g., top third) of the proximal phalange 210 of the first toe 235 and the distal half (e.g., top third) of the proximal phalange 205 of the second toe 240. In other words, the first end 290 is located on the sole 115 at the distal end of the foot 110 in the area connecting the first toe 235 and the second toc 240.

A first section 201 of the path starts 200 at the first end 290 and extends on the sole 115 along the edge of the metatarsophalangeal joint 265 of the second toe 240 facing the metatarsophalangeal joint 260 of the first toe 235 to the lumbrical muscle 270 of the second toc 240.

A second section 202 of the path 200 connects to the first section 201. The second section 202 extends along the edge of the lumbrical muscle 270 of the second toe 240 facing the flexor hallucis 220 of the first toe 235, then crosses the tendon 275 of the flexor digitorum longus and ends on the quadratus plantae 225 laterally offset to the intersection 280 of the abductor hallucis 230 and the tendon 275 of the flexor digitorum longus (e.g., offset by maximum of one and a half centimeters or one centimeter). In other words, the path 200 extends along the lumbrical muscle 270 of the second toe 240 at the side facing the inner side 111 of the foot 110 (facing the flexor hallucis 220 of the first toe 235), then crosses the tendon 275 of the flexor digitorum longus and extends further along the quadratus plantae 225 at the side facing the inner side 111 of the foot 110 to the level of the foot 110 where the abductor hallucis 230 and the tendon 275 of the flexor digitorum longus intersect. The inner side 111 of the foot 110 is the side of the foot 110 facing the other foot of the user. The inner side 111 of the foot 110 is opposite to the outer side 112 of the foot 110. The outer side 112 of the foot 110 is the side of the foot 110 not facing the other foot of the user.

The second section 202 and the first section 201 connect near the Yongquan acupressure point 215. The Yongquan acupressure point 215 lies substantially on the metatarsal bone of the second toe 240 and may extend to the depression between the metatarsal bones of the second toe 240 and the third toe 245.

A third section 203 of the path 200 connects to the second section 202 and extends on the sole 115 along the edge of the quadratus plantae 225 facing the abductor hallucis 230 to the second end 295. In other words, the third section 203 of the path 200 extends along the area bordering the quadratus plantae 225 and the abductor hallucis 230 to the second end 295.

By applying pressure to the sole 115 of the foot 110 along the path 200, beneficial effects on the human body can be achieved, such as relaxation, improved blood circulation in the feet, pain relief or lowering blood pressure.

The width of the path 200 may, e.g., be at maximum 1.75 centimeters (cm), 1.5 cm, 1.25 cm or 1.0 cm. Accordingly, the contact surface of the actuator 130 for contacting the sole 115 may extend at maximum 1.75 cm, 1.5 cm, 1.25 cm or 1.0 cm in the dimension perpendicular to the path 200. In other words, the width of the of pressure application structure 130's contact surface may be 1.75 cm or less, 1.5 cm or less, 1.25 cm or less or 1.0 cm or less.

The pressure application structure 130 may be configured to apply a constant pressure to the sole 115 along the path 200. In other examples, the pressure application structure 130 may be configured to apply a varying pressure to the sole 115 along the path 200. In other words, the pressure application structure 130 may be configured to apply (at least two) different levels of pressure to the sole 115 along the path 200. Applying varying pressure to the sole 115 may allow for improved sensation of the human body. For example, the pressure application structure 130 may be configured to apply less pressure to the sole 115 in the second section 202 than in the first and third sections 201 and 203. Applying less pressure to the sole 115 in the second section 202 may be more comfortable for the human body. Additionally or alternatively, the actuator 130 may be configured to apply more pressure to the sole 115 near (e.g., within a maximum distance of two and a half centimeters, two centimeters, one and a half centimeters or one centimeter to) the Yongquan acupressure point 215 than in the remaining part of the first section 201 and the second section 202.

For example, in case the pressure application structure 130 is an actuator (i.e. non-static), the actuator may be configured to apply a varying pressure to the sole 115 while moving along the path 200. As described above, the actuator may be configured to apply less pressure to the sole 115 while moving along the second section 202 than while moving along the first and third sections 201 and 203. In case the pressure application structure 130 is a (static) protrusion, the height of the protrusion may vary along the path 200 to apply varying pressure to the sole 115 along the path 200. Alternatively or additionally, the protrusion may be formed of one or more materials with varying rigidity to apply varying pressure to the sole 115 along the path 200.

Returning back to FIG. 1, the apparatus 100 may optionally comprise an interface 140 configured to receive an input indicating a pressure to be applied to the sole 115. The interface 140 may be implemented in various ways. For example, the interface 140 may be a Human-Machine Interface (HMI) such as a touchscreen displaying one or more graphical elements for selecting different pressures or pressure profiles to be applied to the sole 115 or one or more buttons for selecting different pressures or pressure profiles to be applied to the sole 115. Accordingly, the input is a user input such as pressing of one of the graphical elements or one of the buttons by the user. The interface 140 allows to directly control the apparatus 100 without the need for external control.

Alternatively or additionally, the interface 140 may comprise a wireless receiver configured to wirelessly receive the input from an external device such as mobile phone, a tablet-computer or a wearable device (e.g., a smartwatch). A wireless interface may allow to control the apparatus by means of the external device (e.g., via an application running on the external device) and may be very convenient for the user. The wireless receiver may be configured to communicate with the external device according to a communication standard such as Wi-Fi (IEEE 802.11), Bluetooth or Near-Field Communication (NFC).

The interface 140 allows to control the pressure application structure 130 in case the pressure application structure 130 is an actuator. The interface 140 may be coupled to the actuator 130 of the apparatus 100 and configured to transmit (forward, provide) information indicating the input to the actuator 130 such that the actuator 130 is able to process the input and applies pressure to the sole 115 according to the input. In other examples, the interface 140 may be coupled to processing circuitry 150 of the apparatus 100 for controlling the actuator 130. The processing circuitry 150 processes the input and controls the actuator 130 to apply pressure to the sole 115 according to the input.

The processing circuitry 150 may, e.g., be a single dedicated processor, a single shared processor, a digital signal processor (DSP) hardware, an application specific integrated circuit (ASIC), or a field programmable gate array (FPGA). The processing circuitry 150 may optionally be coupled to, e.g., memory such as read only memory (ROM) for storing software, random access memory (RAM) and/or non-volatile memory. For example, the apparatus 100 may comprise memory configured to store instructions, which when executed by the processing circuitry 150, cause the processing circuitry 150 to perform the steps and methods described herein.

Independent from the implementation of the interface 140, the input for controlling the pressure to be applied to the sole 115 may, e.g., indicate one of a plurality of predefined pressure profiles for the pressure to be applied to the sole 115. A pressure profile indicates the target pressure to be applied to the sole 115 along the path 200. For example, the predefined pressure profiles may indicate high pressure to be applied to the sole 115 (for a hard massage/foot treatment), medium pressure to be applied to the sole 115 (for a medium massage/foot treatment) or low pressure to be applied to the sole 115 (for a soft massage/foot treatment). Additionally or alternatively, the predefined pressure profiles may indicate different variations of the pressure to be applied to the sole 115 along the path 200. The plurality of predefined pressure profiles allow the user to select a foot treatment according to his/her desires.

During the treatment, in case the pressure application structure 130 is an actuator, the actuator 130 may be configured to repeatedly apply pressure to the sole 115 along the path 200 by repeatedly (i.e., multiple times) moving back and forth along the path 200. The actuator 130 may repeatedly move back and forth along the entire path 200 or along one or more parts of the path 200 such as the first, second and third sections 201, 202 and 203. Repeatedly moving back and forth along the path 200, allows the actuator 130 to repeatedly apply pressure to the sole 115 and, hence, improve the effects on the human body caused by the foot treatment.

The actuator 130 may, while moving along the path 200, be configured to remain for at least one second (or at least two, three, four or five seconds) within a maximum distance of two and a half centimeters, two centimeters, one and a half centimeters or one centimeter to the Yongquan acupressure point 215 and apply pressure to the sole 115. For example, the actuator 130 may be configured to repeated move back and forth over the Yongquan acupressure point 215 or near (i.e., in the vicinity of) the Yongquan acupressure point 215 during this time period. Applying pressure to or near the Yongquan acupressure point 215, i.e., massaging the Yongquan acupressure point 215 or its vicinity, may allow to achieve various beneficial effects on the human body, such as overcoming headache, blurring of vision, dizziness, sore throat or feverish sensation in the sole 115.

It may be beneficial to apply pressure to the sole 115 perpendicular to the surface of the sole 115. Therefore, according to some examples of the present disclosure, the apparatus 100 may further comprise a sensor 160 configured to measure a surface orientation of the sole 115. For example, the sensor 160 may comprise or be an optical camera configured to measure still images or moving images of the sole 115 for determining the surface orientation of the sole 115 by image analysis. Alternatively or additionally, the sensor 160 may comprise or be a Time-of-Flight (ToF) sensor measuring distances to the sole 115 for determining the surface orientation of the sole 115 therefrom. However, it is to be noted that the present disclosure is not limited to the foregoing examples. Other sensing techniques for measuring the surface orientation of the sole 115 may be used as well. Accordingly, in case the pressure application structure 130 is an actuator, the actuator 130 may be configured to apply pressure to the sole 115 perpendicularly to the measured surface orientation of the sole 115 based on the measured surface orientation of the sole 115. For example, the actuator 130 may be configured to dynamically adjust the orientation of its contact surface such that it is perpendicular to the measured surface orientation of the sole 115 while moving along the path 200. In some examples, the processing circuitry 150 may be configured to receive the measurement data of the sensor 160 and (e.g., dynamically) determine a target orientation for the contact surface of the actuator along the path 200. Accordingly, the processing circuitry 150 may be configured to control the actuator 130 to (e.g., dynamically) adjust the orientation of its contact surface based on the determined target orientation.

The sensor 160 or another sensor of the apparatus 100 may optionally be configured to measure dimensions of the sole 115 and/or portions thereof. The other sensor may, e.g., be like the sensor 160 and/or comprise or be a pressure sensor allowing to measure the measure dimensions of the sole 115 based on the differences between the measured pressure values. For example, the measured pressure values may be high for a first region on which the foot 110 is located and be significantly lower in a second region surrounding the first region. By comparing the measurement values, the dimensions of the first region may be determined. The dimensions of the first region are substantially the dimension of the foot 110.

The measured dimensions of the sole 115 and/or portions thereof may be used to determine the path 200 individually for each user. For example, the processing circuitry 150 may be configured to generate the path 200 by adapting a default path based on the measured dimensions. The default path may be defined for a foot of given dimensions and not fit perfectly for the foot 110 of the user. Accordingly, by adapting (e.g., scaling) the default path based on the measured dimensions (e.g., in relation to the given dimensions for the default path), the path 200 may be optimized to the dimensions of the user foot 110. Hence, the foot treatment may be improved for the user.

In some examples, in case the pressure application structure 130 is an actuator, the actuator 130 may be configured to form a protrusion (ridge) on the surface 125 according to the path 200 (e.g., as individually determined for the user based on the measured dimensions of the sole 115 and/or portions thereof). The extension of the protrusion on the surface 125 is identical to the path 200 (e.g., as individually determined for the user based on the measured dimensions of the sole 115 and/or portions thereof). Accordingly, an effective static protrusion for applying pressure to the sole 115 along a user individual path may be provided. For example, the actuator 130 may comprise a plurality of movable sub-structures (sub-elements) which are movable relative to the surface 125 (e.g., be driven into the surface 125 and be driven out of the surface 125) and which are at least in part driven out of the surface 125 based on the user individual shape of the path 200 by a drive system of the actuator 130. In particular, the drive system may be configured to drive at least part of the movable sub-structures out of the surface 125 to form a protrusion according to the path 200 (e.g., as individually determined for the user based on the measured dimensions of the sole 115 and/or portions thereof) on the surface 125. In this example, the protrusion on the surface 125 is electronically adjustable to match the path 200.

The processing circuitry 150 may, e.g., be configured to use a trained machine-learning model receiving the measured dimensions as input for adapting the default path.

The machine-learning model is a data structure and/or set of rules representing a statistical model that the processing circuitry 150 uses to adapt the default path without using explicit instructions, instead relying on models and inference. The data structure and/or set of rules represents learned knowledge (e.g. based on training performed by a machine-learning algorithm as described below). In machine-learning, instead of a rule-based transformation of data, a transformation of data may be used, that is inferred from an analysis of training data.

The machine-learning model is trained by a machine-learning algorithm. The term “machine-learning algorithm” denotes a set of instructions that are used to create, train or use a machine-learning model. For the machine-learning model to adapt the default path, the machine-learning model may be trained using training data such as known dimensions of a foot as input and a path on the sole of the foot for applying pressure as target output. By training the machine-learning model with a large set of training data and associated training content information, the machine-learning model “learns” to adapt the default path in the training data, so that a target path on the sole for applying pressure is obtained using the machine-learning model. By training the machine-learning model using training information on dimensions of the foot, the machine-learning model “learns” a transformation between the input training data and the desired output, which can be used to provide an output based on non-training characteristics of the foot provided to the machine-learning model.

The machine-learning model may be trained using training input data (e.g. known dimensions of a foot). For example, the machine-learning model may be trained using a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training. For example, a training sample may comprise known dimensions of a foot as input data and a given (known) path on the sole of the foot for applying pressure as desired output data.

Apart from supervised learning, semi-supervised learning may be used. In semi-supervised learning, some of the training samples lack a corresponding desired output value. Supervised learning may be based on a supervised learning algorithm (e.g. a classification algorithm or a similarity learning algorithm).

Apart from supervised or semi-supervised learning, unsupervised learning may be used to train the machine-learning model. In unsupervised learning, (only) input data are supplied and an unsupervised learning algorithm is used to find structure in the input data. Clustering is the assignment of input data comprising a plurality of input values into subsets (clusters) so that input values within the same cluster are similar according to one or more (pre-defined) similarity criteria, while being dissimilar to input values that are included in other clusters. The input data for the unsupervised learning may be known dimensions of a foot.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such that the cumulative reward is increased, leading to software agents that become better at the task they are given (as evidenced by increasing rewards).

Furthermore, additional techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

For example, the machine-learning model may be an Artificial Neural Network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values (e.g., measured dimensions of foot), hidden nodes that are (only) connected to other nodes, and output nodes that provide output values (e.g., path on the sole of the foot for applying pressure). Each node may represent an artificial neuron. Each edge may transmit information from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an ANN may comprise adjusting the weights of the nodes and/or edges of the ANN, i.e., to achieve a desired output for a given input.

Alternatively, the machine-learning model may comprise a different structure and, e.g., be a support vector machine, a random forest model or a gradient boosting model. Alternatively, the machine-learning model may be based on a genetic algorithm, which is a search algorithm and heuristic technique that mimics the process of natural selection.

In some examples, the machine-learning model may be a combination of the above examples.

According to other examples of the present disclosure, the path 200 may be generated based on an image of the sole 115 and/or portions thereof. For example, the processing circuitry 150 may be configured to receive the image of the sole 115 and/or portions thereof. The image may, e.g., be received from the sensor 160 or an entity external to the apparatus 100. For example, the image may be received from an external camera or a mobile device of the user (e.g., a mobile phone or a tablet-computer). The image may be a still image. The image may be a color image or a black-and-white image. In addition to the sole 115 and/or portions thereof, the image may depict further elements. For example, the image may additionally depict a reference object of known size such that the dimensions of the sole 115 and/or portions thereof may be derived from the image. Alternatively, information/data about the dimensions of the sole 115 and/or portions thereof may be provided separate from the image (e.g., by a user or another person/specifying the shoe size of the user).

The processing circuitry 150 may be further configured to generate the path 200 using a trained machine-learning model receiving the image as input. In these examples, the machine-learning model is a data structure and/or set of rules representing a statistical model that the processing circuitry 150 uses to generate the path 200 without using explicit instructions, instead relying on models and inference. The data structure and/or set of rules represents learned knowledge (e.g. based on training performed by a machine-learning algorithm as described above).

The structure of the machine-learning model may be as described above. Furthermore, the machine-learning model may be trained according to the training principles (approaches) described above. For training the machine-learning model to generate the path 200 from an image of the sole 115 and/or portions thereof, adapted training samples may be used. For example, a training sample may comprise an image of known sole and/or portions thereof as input data and a given (known) path on the sole for applying pressure as desired output data. By training the machine-learning according to one of the above training principles (approaches) with the adapted training samples, machine-learning model “learns” to generate or derive paths for applying pressure based on images of soles or parts thereof. As described above, the image may additionally depict a reference object of known size or information/data about the dimensions of the sole 115 and/or portions thereof may be provided separate from the image such that the trained machine-learning model may derive or be made aware of the dimensions of the sole 115 and/or portions thereof. According to examples, the images used as input data for the training samples may depict reference objects of known size such that the dimensions of the depicted sole and/or portions thereof may be derived from the image. Alternatively, information about the dimensions of the soles depicted in the images used as input data for the training samples and/or portions thereof may be provided separate from the images used as input data for the training samples. Accordingly, the machine-learning model may “learn” to generate or derive paths for applying pressure taking into account the information about the dimensions of the soles.

The apparatus 100 may optionally further comprise an oil application structure 170 configured to apply oil to the sole 115. In particular, the oil application structure 170 may be configured to apply the oil along at least part of the (e.g., the entire) path 200. For example, the oil may be a massage oil such as coconut oil, olive oil, almond oil, jojoba oil or lavender oil. However, it should be noted that other types of oil may be used as well.

The oil application structure 170 may be separate from the pressure application structure 130 as illustrated in FIG. 1. In other examples, the oil application structure 170 may be integrated into, i.e., be part of the pressure application structure 130. The oil application structure 170 may, e.g., comprise delivery (transport) means (a delivery/transport system) such as a delivery (transport) pump and/or a delivery (transport) line to deliver (transport) the oil from a reservoir (tank) to a discharge (dispensing, release) means (system) of the structure. The discharge means is configured to apply the delivered oil to the sole 115. The reservoir for the oil may be part of the apparatus 100 or be external to apparatus 100. In case the application structure 170 is integrated into the pressure application structure 130, the delivery means may (at least in part) be arranged within the pressure application structure 130. If the oil application structure 170 is an element separate from the pressure application structure 130, the oil application structure 170 may be configured to move synchronously with the pressure application structure 130.

The oil application structure 170 may, e.g., be arranged to apply the oil continuously or automatically along the path 200. In other examples, the oil application structure 170 or the pressure application structure 130 may comprise a sensor configured to measure a roughness or friction resistance of the sole 115 along the path 200. If the measured roughness or friction resistance of the sole 115 is above a threshold value along a part of the path 200, the oil application structure 170 may be configured to apply the oil to this part. In other examples, the oil application structure 170 may be configured to apply the oil based on a user input (indicating a user's desire for the application of oil). For example, the sensor may be a moisture sensor or another type of sensor such as a mechanical sensor.

The applied oil may allow for smoother and more fluid movements, reducing friction and providing a calming, soothing experience that promotes deep relaxation. Furthermore, the applied oil may help moisturize and nourish dry or cracked skin on the sole 115, leaving the sole feeling soft and hydrated.

The oil application structure 170 may be configured to apply the oil at a target temperature (e.g., similar to the human body temperature) to enhance the comfort of the user during the treatment. For example, the oil application structure 170 may comprise a heater (not illustrated in FIG. 1) configured to heat the oil to the target temperature.

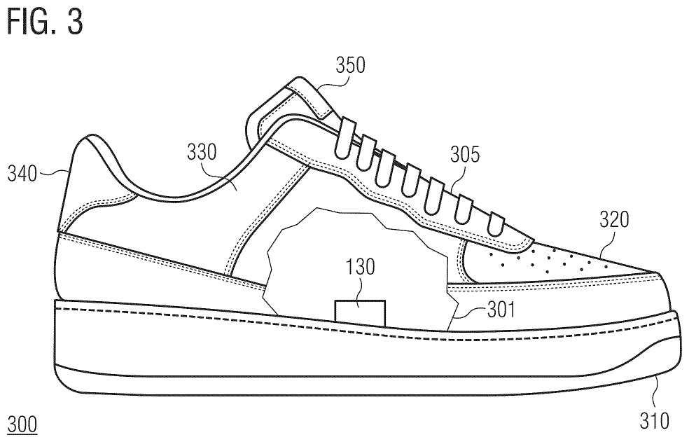

As indicated above, an apparatus for treating a sole of a foot according to the present disclosure may be used for mobile, i.e., non-stationary applications. FIG. 3 illustrates a shoe 300 as example for a mobile application.

The apparatus 100 for treating a sole of a foot according to the present disclosure is integrated into the shoe 300. The sole 310 of the shoe 300 serves as the receiving structure. In other words, the sole 310 may be designed as described above for the receiving structure 120. Further elements of the shoe 310 such as the upper 305 including the toe box 320, the upper (vamp) 330, the heel cap 340 or the tongue 350 may also be considered as part of the receiving structure as the keep the foot of the user in place.

An imaginary cutout 301 in the upper 305 is illustrated in FIG. 3 to show the inside of the shoe 300. As can be seen from FIG. 3, the pressure application structure 130 is further integrated into the sole 310 of the shoe 300 such that pressure may be applied to the foot of a user while the user is wearing the shoe. As described above, the pressure application structure 130 may be a static protrusion or a movable actuator. For example, in case the pressure application structure 130 is a protrusion, the protrusion may be formed on the sole 310.

The further optional elements of the apparatus 100 such as the interface 140, the processing circuitry 150 or the sensor 160 may likewise be integrated into the shoe (e.g., into the sole 310 of the shoe 300). Similarly, one or more batteries for supplying the apparatus 100 with electrical energy may be integrated into the shoe 300 (e.g., into the sole 310 of the shoe 300).

The sole 310 may be formed integrally or by a plurality of sub-elements such as an outsole, a mid-sole and/or an insole.

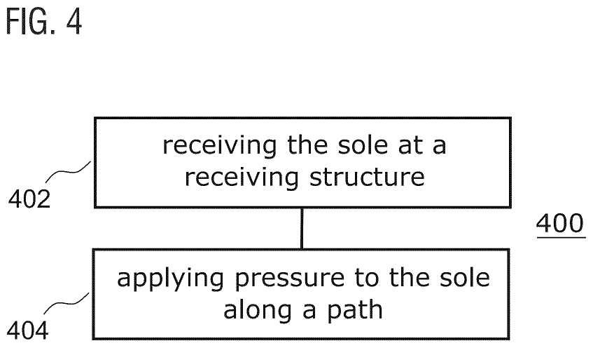

For further illustrating the treatment of the sole described above, FIG. 4 illustrates a flowchart of a method 400 for treating a sole of a foot. The method 400 comprises receiving 402 the sole at a receiving structure (such as the receiving structure 100 described above). Additionally, the method 400 comprises applying 404, by means of a pressure application structure (such as the pressure application structure 130 described above), pressure to the sole along a path while the sole is received by the receiving structure. The path extends from a first end to a second end on the sole. The first end is located at the distal end of the foot between the proximal phalange of the first toe and the proximal phalange of the second toe. The second end is located at the heel of the foot. A first section of the path starts at the first end and extends on the sole along the edge of the metatarsophalangeal joint of the second toe facing the metatarsophalangeal joint of the first toe to the lumbrical muscle of the second toe. A second section of the path connects to the first section and extends along the edge of the lumbrical muscle of the second toe facing the flexor hallucis of the first toe, (then) crosses the tendon of the flexor digitorum longus and ends on the quadratus plantae laterally offset to the intersection of the abductor hallucis and the tendon of the flexor digitorum longus. A third section of the path connects to the second section and extends on the sole along the edge of the quadratus plantae facing the abductor hallucis to the second end.

The method 400 may allow to achieve beneficial effects on the human body, such as relaxation, improved blood circulation in the feet, pain relief or lowering blood pressure.

More details and aspects of the method 400 are explained in connection with the proposed technique or one or more examples described above (e.g. FIGS. 1 to 3). The method 400 may comprise one or more additional optional features corresponding to one or more aspects of the proposed technique or one or more examples described above.

The aspects and features described in relation to a particular one of the previous examples may also be combined with one or more of the further examples to replace an identical or similar feature of that further example or to additionally introduce the features into the further example.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for treating a sole of a foot, the apparatus comprising:
a receiving structure for receiving the sole; and
a pressure application structure configured to apply pressure to the sole along a path while the sole is received by the receiving structure, wherein the path extends from a first end to a second end on the sole, wherein the first end is located at a distal end of the foot between the proximal phalange of the first toe and the proximal phalange of the second toe, wherein the second end is located at the heel of the foot, wherein a first section of the path starts at the first end and extends on the sole along the edge of the metatarsophalangeal joint of the second toe facing the metatarsophalangeal joint of the first toe to the lumbrical muscle of the second toe, wherein a second section of the path connects to the first section and extends along the edge of the lumbrical muscle of the second toe facing the flexor hallucis of the first toe, crosses the tendon of the flexor digitorum longus and ends on the quadratus plantae laterally offset to the intersection of the abductor hallucis and the tendon of the flexor digitorum longus, and wherein a third section of the path connects to the second section and extends on the sole along the edge of the quadratus plantae facing the abductor hallucis to the second end.

2. The apparatus of claim 1, wherein the pressure application structure is an actuator configured to apply a varying pressure to the sole along the path.

3. The apparatus of claim 2, wherein the actuator is configured to apply less pressure to the sole while moving along the second section than while moving along the first and third sections.

4. The apparatus of claim 1, wherein the pressure application structure is an actuator configured to repeatedly apply pressure to the sole along the path by repeatedly moving back and forth along the path.

5. The apparatus of claim 1, wherein the pressure application structure is an actuator configured to remain for at least one second within a maximum distance of two and a half centimeters to the Yongquan acupressure point and apply pressure to the sole while moving along the path.

6. The apparatus of claim 1, wherein the pressure application structure is an actuator comprising:
plurality of movable sub-structures which are movable relative to a surface of the receiving structure; and
a drive system configured to drive at least part of the movable sub-structures out of the surface to form a protrusion according to the path on the surface.

7. The apparatus of claim 1, further comprising an interface configured to receive an input indicating a pressure to be applied to the sole.

8. The apparatus of claim 7, wherein the input for controlling the pressure to be applied to the sole indicates one of a plurality of predefined pressure profiles for the pressure to be applied to the sole.

9. The apparatus of claim 7, wherein the interface is a human-machine interface, and wherein the input is a user input.

10. The apparatus of claim 1, further comprising a sensor configured to measure a surface orientation of the sole, wherein the pressure application structure is an actuator configured to apply pressure to the sole perpendicularly to the measured surface orientation of the sole.

11. The apparatus of claim 1, further comprising:
a sensor configured to measure dimensions of the sole and/or portions thereof; and
processing circuitry configured to generate the path by adapting a default path based on the measured dimensions.

12. The apparatus of claim 1, further comprising processing circuitry configured to:
receive an image of the sole and/or portions thereof; and
generate the path using a trained machine-learning model receiving the image as input.

13. The apparatus of claim 1, wherein the pressure application structure is a static protrusion formed on a surface of the receiving structure for receiving the sole.

14. The apparatus of claim 1, wherein a contact surface of the pressure application structure for contacting the sole extends at maximum 1.75 centimeters in a dimension perpendicular to the path.

15. The apparatus of claim 1, further comprising an oil application structure configured to apply oil to the sole.

16. A shoe comprising an apparatus according to claim 1, wherein a sole of the shoe is the receiving structure of the apparatus, and wherein the pressure application structure of the apparatus is integrated into the sole of the shoe.

17. A method for treating a sole of a foot, the method comprising:
receiving the sole at a receiving structure; and
applying, by means of a pressure application structure, pressure to the sole along a path while the sole is received by the receiving structure, wherein the path extends from a first end to a second end on the sole, wherein the first end is located between the top third of the proximal phalange of the first toe and the top third of the proximal phalange of the second toe, wherein the second end is located at the heel of the foot, wherein a first section of the path starts at the first end and extends on the sole along the edge of the metatarsophalangeal joint of the second toe facing the metatarsophalangeal joint of the first toe to the lumbrical muscle of the second toe, wherein a second section of the path connects to the first section and extends along the edge of the lumbrical muscle of the second toe facing the flexor hallucis of the first toe, crosses the tendon of the flexor digitorum longus and ends on the quadratus plantae laterally offset to the intersection of the abductor hallucis and the tendon of the flexor digitorum longus, and wherein a third section of the path connects to the second section and extends on the sole along the edge of the quadratus plantae facing the abductor hallucis to the second end.
